(19) United States
(12) Patent Application Publication
(10) Pub. No.: US 2022/0393333 A1
(43) Pub. Date: Dec. 8, 2022

(54) ANTENNA MOUNTING DEVICE AND ANTENNA SYSTEM FOR ANTENNA ASSEMBLY

(71) Applicant: CommScope Technologies LLC, Hickory, NC (US)

(72) Inventors: Nengbin Liu, Suzhou (CN); Zhigang Wang, Suzhou (CN); Ruixin Su, Suzhou (CN); PuLiang Tang, Suzhou (CN); Hongwen Zhu, Suzhou (CN)

(21) Appl. No.: 17/732,915

(22) Filed: Apr. 29, 2022

(30) Foreign Application Priority Data
Jun. 8, 2021 (CN) 202110635316.8

(51) Int. Cl. H01Q 1/12

(52) U.S. Cl. CPC H01Q 1/125; H01Q 1/1228

(57) ABSTRACT

The present disclosure relates to an antenna mounting device for antenna assembly, where the antenna assembly comprises a base station antenna that extends longitudinally and a remote radio unit. The antenna mounting device comprises a first mounting unit, a second mounting unit and an optional third mounting unit. The first mounting unit is configured to pivotally connect a remote radio unit to a foundational component and provide the antenna assembly with a pivot point relative to the foundational component. The second mounting unit is configured to connect the base station antenna to a foundational component in the longitudinal extension direction of the base station antenna, below the first mounting unit and at a distance from the first mounting unit. The second mounting unit has an adjustable effective connection length between the base station antenna and foundational component, where the effective connection length determines the mechanical tilt angle of the antenna assembly. The present disclosure further comprises an antenna system of the antenna mounting device.

### RELATED APPLICATION

The present application claims priority from and the benefit of Chinese Patent Application No. 202110635316.8, filed Jun. 8, 2021, the disclosure of which is hereby incorporated by reference herein in full.

### FIELD OF THE INVENTION

The present disclosure relates to the field of radio communication technology, and more specifically to an antenna mounting device for antenna assembly and an antenna system comprising such an antenna mounting device.

### BACKGROUND OF THE INVENTION

In a radio communication system, the transmission and reception of radio frequency signals can be realized via base station antennas. The position of the base station antenna is important for radio communication network; for example, it may affect the coverage of the base station antenna. The position of the base station antenna may need to be adjusted during the mounting and use of the base station antenna. With the continual improvement and popularization of 5G communication technology, base station antennas are becoming more and more integrated and the weight of base station antennas is also increasing accordingly. On one hand, it is desirable to minimize the area occupied by base station antennas. On the other hand, it is also desirable to improve the performance of base station antennas in resisting environmental influences, for example, resisting wind load.

FIG. 1 and FIG. 2 show an antenna mounting device known in practice, where an antenna assembly 20 comprising a base station antenna 21 and a remote radio unit 22 is mounted onto the foundational component 23 via an adjustable antenna mounting device. The foundational component 23 may be a pole, communication tower pole, or a general building, etc. In FIG. 1, the base station antenna 21 is substantially parallel to the foundational component 23, and has a plurality of mechanical tilt angles that are substantially zero. In FIG. 1, the base station antenna 21 has a mechanical tilt angle of approximately 5°. The antenna mounting device comprises: an upper mounting unit which has an adjustable effective connection length; a middle mounting unit with a similarly adjustable effective connection length; and a lower mounting unit which provides the antenna assembly 20 with a pivot point relative to the foundational component 23. Due to the presence of a remote radio unit 22, the middle mounting unit is equipped with a spacing compensation component 24 which is connected between the middle mounting unit and base station antenna 21; the lower mounting unit is equipped with a spacing compensation component 25 which is connected between the middle mounting unit and the base station antenna 21. The antenna system comprising an antenna mounting device and antenna assembly may occupy a larger space. In addition, the capability of this antenna system to withstand wind load should have further room for improvement.

### SUMMARY OF THE INVENTION

The purpose of the present disclosure is to provide an antenna mounting device for antenna assembly and an antenna system comprising such an antenna mounting device, in which the area occupied by the antenna system may be reduced and its performance in resisting environmental influences, especially wind load, may be improved through the antenna mounting device.

A first aspect of the present disclosure relates to an antenna mounting device for antenna assembly, wherein the antenna assembly comprises a base station antenna that extends longitudinally and a remote radio unit mounted on a lateral surface of the base station antenna and adjacent to a longitudinal end of the base station antenna.

The antenna mounting device comprises: a first mounting unit, where the first mounting unit is configured to pivotally connect the remote radio unit of the base station antenna assembly to a foundational component and provide the antenna assembly with a pivot point relative to the foundational component; and a second mounting unit, where the second mounting unit is configured to connect the base station antenna of the base station antenna assembly to a foundational component in the longitudinal extension direction of the base station antenna, below the first mounting unit and at a distance from the first mounting unit, in which, the second mounting unit has an adjustable effective connection length between the base station antenna and foundational component, where the effective connection length determines the angle of the antenna assembly relative to the foundational component and thereby determines the mechanical tilt angle of the antenna assembly.

In some embodiments, the second mounting unit may comprise a first articulating arm and a second articulating arm hinged to each other, where the first articulating arm of the second mounting unit is further configured to be connected by a hinge to the foundational component or an accessory fixedly connected to the foundational component, and the second articulating arm of the second mounting unit is further configured to be connected by a hinge to the base station antenna or fixedly connected to an accessory of the base station antenna.

In some embodiments, the first articulating arm and second mounting unit of the second mounting unit may fold or to say open downwards or upwards.

In some embodiments, the antenna mounting device may comprise a third mounting unit between the first mounting unit and second mounting unit in the longitudinal extension direction of the base station antenna, where the third mounting unit is configured to connect the base station antenna of the base station antenna assembly to the foundational component, in which, the third mounting unit has an adjustable effective connection length between the base station antenna and foundational component and the effective connection length of the third mounting unit adapts to the effective connection length of the second mounting unit.

In some embodiments, the third mounting unit may comprise a first articulating arm and a second articulating arm hinged to each other, where the first articulating arm of the third mounting unit is further configured to be connected by a hinge to the foundational component or an accessory fixedly connected to the foundational component, and the second articulating arm of the third mounting unit is further configured to be connected by a hinge to the base station antenna or fixedly connectedly to an accessory of the base station antenna.

In some embodiments, the first articulating arm and second articulating arm of the third mounting unit may open downwards or upwards.

In some embodiments, the second mounting unit and/or third mounting unit may comprise at least two telescopic rod elements that can be mated to each other. The rod elements may be straight rods or curved rods. The telescopic movement of the at least two rod elements realizes adjustable effective connection length.

In some embodiments, the second mounting unit may comprise a lockable locking device and the locking device is configured to lock the effective connection length of the second mounting unit.

In some embodiments, the effective connection length of the second mounting unit may be stepless-adjustable or step-adjustable.

In some embodiments, measuring in the longitudinal extension direction of the base station antenna, the longitudinal distance between the connection between the first mounting unit and remote radio unit and the longitudinal end of the base station antenna may not be larger than ⅙ of the size of the longitudinal extension of the base station antenna.

In some embodiments, measuring in the longitudinal extension direction of the base station antenna, the longitudinal distance between the connection between the second mounting unit and base station antenna and the other longitudinal end of the base station antenna that is opposite the longitudinal end may not be larger than ⅙ of the size of the longitudinal extension of the base station antenna.

In some embodiments, measuring in the longitudinal extension direction of the base station antenna, the longitudinal distance between the connection between the third mounting unit and base station antenna and the longitudinal center point of the base station antenna may not be larger than ⅙, especially not larger than 1/12 of the size of the longitudinal extension of the base station antenna.

A second aspect of the present disclosure relates to an antenna system, comprising an antenna assembly, where the antenna assembly comprises a base station antenna that extends longitudinally and a remote radio unit mounted on a lateral surface of the base station antenna and adjacent to a longitudinal end of the base station antenna. The antenna system further comprises an antenna mounting device for antenna assembly according to the first aspect, where the antenna assembly is mounted onto the foundational component by leveraging the antenna mounting device.

Compared to known prior art, in the antenna system of the present disclosure, the center of the antenna assembly may be closer to the pivot point of the antenna assembly. This is conducive for stably supporting the antenna system and improving its performance in resisting environmental influences.

The above-mentioned technical features, the technical features to be mentioned below and the technical features shown separately in the drawings can be arbitrarily combined with each other as long as the combined technical features are not contradictory. All technically feasible characteristic combinations are technical contents stated herein.

### DESCRIPTION OF THE DRAWINGS

The present disclosure will be explained in more detail by means of exemplary embodiments with reference to the attached drawings. Among them,

FIG. 1 and FIG. 2 are schematic diagrams of a known antenna mounting device and antenna system in two different states.

FIG. 3 and FIG. 4 are schematic diagrams of an antenna mounting device and antenna system in two different states according to the first embodiment of the present disclosure.

FIG. 5 and FIG. 6 are schematic diagrams of an antenna mounting device and antenna system in two different states according to the second embodiment of the present disclosure.

FIG. 7 is a schematic diagram of an antenna mounting device and antenna system according to the third embodiment of the present disclosure.

FIG. 8 is a schematic diagram of an antenna mounting device and antenna system according to the fourth embodiment of the present disclosure.

### DETAILED DESCRIPTION OF SPECIFIC EMBODIMENTS

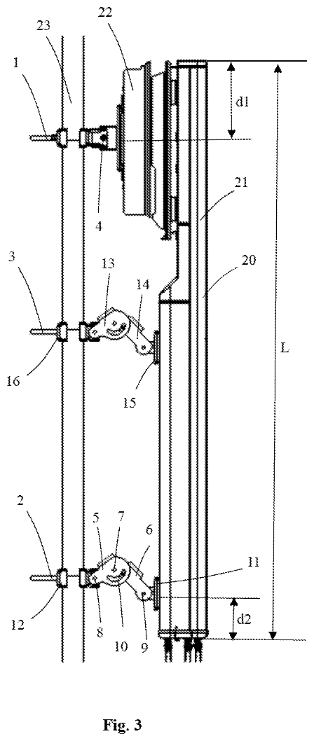

First, an antenna mounting device and antenna system according to the first embodiment of the present disclosure are described with reference to FIG. 3 and FIG. 4. An antenna assembly 20 may comprise a base station antenna 21 that extends longitudinally and a remote radio unit 22 mounted on a lateral surface of the base station antenna 21 and adjacent to an upper longitudinal end of the base station antenna 21. Antenna assembly 20 may be mounted onto a foundational component 23, for example, a pole, by leveraging the antenna mounting device. Typically, the remote radio unit 22 may be substantially aligned to the upper longitudinal end of the base station antenna 21.

The antenna mounting device may comprise a first mounting unit 1, which may also be referred to as an upper mounting unit. The first mounting unit 1 may be configured to directly pivotally connect the remote radio unit 22 of the base station antenna assembly 20 to the foundational component 23 and provide the antenna assembly 20 with a pivot point 4 relative to the foundational component 23. The first mounting unit 1 may comprise a clamping device which is clamped and fixed onto the foundational component 23 as an accessory. The longitudinal distance d1 between the connection between the first mounting unit 1 and the remote radio unit 22 and the upper longitudinal end of the base station antenna 21 is usually no larger than ⅙ of the size of the longitudinal extension L of the base station antenna.

The antenna mounting device may comprise a second mounting unit 2, which may also be referred to as a lower mounting unit. The second mounting unit 2 may be configured to connect the base station antenna 21 of the base station antenna assembly 20 to the foundational component 23 in the longitudinal extension direction of the base station antenna 21, below the first mounting unit 1 and at a distance from the first mounting unit 1. Measuring in the longitudinal extension direction of the base station antenna 21, the longitudinal distance d2 between the connection between the second mounting unit 2 and the base station antenna 21 and the lower longitudinal end of the base station antenna is usually no larger than ⅙ of the size of the longitudinal extension L of the base station antenna 21.

The second mounting unit 2 may have an adjustable effective connection length between the base station antenna 21 and foundational component 23, where the effective connection length determines the angle of the antenna assembly 20 relative to the foundational component 23 and thereby determines the mechanical tilt angle of the antenna assembly. In the state shown in FIG. 3, the foundational component 23 extends vertically, the longitudinal extension direction of the base station antenna 21 is in a vertical direction, and the antenna assembly 20 or the base station antenna 21 has a mechanical tilt angle of 0°. In the state shown in FIG. 4, the longitudinal extension direction of the base station antenna 21 and the vertical direction form an included angle of approximately 5°, and the antenna assembly 20 or the base station antenna 21 has a mechanical tilt angle of approximately 5°. It can be understood that the foundational component 23 does not have to extend vertically and may also extend obliquely.

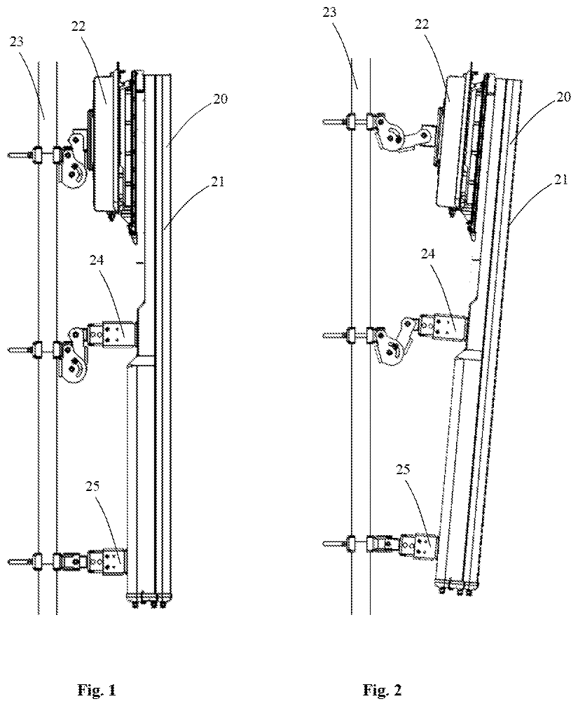

The second mounting unit 2 may comprise a first articulating arm 5 and a second articulating arm 6, which are hinged to each other at a connection 7. The first articulating arm 5 is further configured to be connected by a hinge to an accessory 12 fixedly connected to the foundational component 23 at a connection 8. The second articulating arm 6 is further configured to be connected by a hinge to an accessory 11 fixedly connected to the base station antenna 21 at a connection 9. Accessory 12 may be a clamping device, which may be clamped and fixed onto the foundational component 23. Accessory 11 is different from the spacing compensation component 25 shown in FIG. 1 and FIG. 2. Accessory 11 is not designed for spacing compensation but designed to connect the second mounting unit 2 to the base station antenna 21. If connecting components, for example, lugs or mounting holes, are already integrated on the radome of the base station antenna 21, the second mounting unit 2 may be directly connected to the base station antenna 21, in which, accessory 11 may be cancelled.

The second mounting unit 2 may comprise a releasable and lockable locking device, where the locking device is configured to lock the effective connection length of the second mounting unit 2. For example, the first articulating arm 5 may have a curved extending long groove 10, where the two long sides of the long groove may have evenly distributed teeth opposite to each other and these teeth in the long groove 10 may define a plurality of predetermined angular positions of the second articulating arm 6 relative to the first articulating arm 5. The second articulating arm 6 may be equipped with a movable bolt in the long groove 10. When nuts rotated on bolts are embedded between two adjacent teeth in each long side of the long groove 10, the second articulating arm 6 may be fixed to one of the angular positions relative to the first articulating arm 5. When the nuts leave the long groove 10, the bolts in the long groove are released and movable again. The effective connection length of the second mounting unit 2 may be step-adjustably locked through such a locking device.

The antenna mounting device may further comprise a third mounting unit 3 between the first mounting unit 1 and second mounting unit 2 in the longitudinal extension direction of the base station antenna 21 and it may also be referred to as a middle mounting unit. The third mounting unit 3 may be configured to connect the base station antenna 21 of the base station antenna assembly 20 to the foundational component 23. The third mounting unit 3 may have an adjustable effective connection length between the base station antenna 21 and foundational component 23, where the effective connection length of the third mounting unit 3 adapts to the effective connection length of the second mounting unit 2.

The third mounting unit 3 may also have the same or a similar configuration as the second mounting unit 2. Therefore, the third mounting unit 3 may comprise a first articulating arm 13 and a second articulating arm 14 hinged to each other, where the first articulating arm 13 is further configured to be connected by a hinge to an accessory 16 fixedly connected to the foundational component and the second articulating arm 14 is further configured to be connected by a hinge to an accessory 15 fixedly connected to the base station antenna. In order to avoid repetition, the description of accessories 11 and 12 may be referred to for accessories 15 and 16 and the description of the locking device of the second mounting unit 2 may be referred to for the locking device of the third mounting unit 3. It can be understood that the second mounting unit 2 may also not have a locking device. The spacing compensation component 24 shown in FIG. 1 and FIG. 2 may be herein cancelled. This means that the weight of and space occupied by the antenna system are reduced.

In the embodiments shown in FIG. 3 and FIG. 4, the first articulating arm 5 and second articulating arm 6 of the second mounting unit 2 open downwards, and the first articulating arm 13 and second articulating arm 14 of the third mounting unit 3 open downwards.

In the antenna mounting device of prior art shown in FIG. 1 and FIG. 2, when predetermining the mechanical tilt angle starting from a mechanical tilt angle of 0°, the respective two articulating arms of the upper mounting unit and middle mounting unit open from a basically closed state. Contrary to this, in the first embodiment of the present disclosure shown in FIG. 3 and FIG. 4, when predetermining the mechanical tilt angle starting from a mechanical tilt angle of 0°, the relatively large flare angle of the respective two articulating arms of the second mounting unit and third mounting unit transforms into a relatively small flare angle.

In some embodiments that are not shown, two telescopic arms may also be used instead of the two articulating arms. Pulling these two arms away from each other makes the effective connection length longer and pushing these two arms towards each other makes the effective connection length shorter.

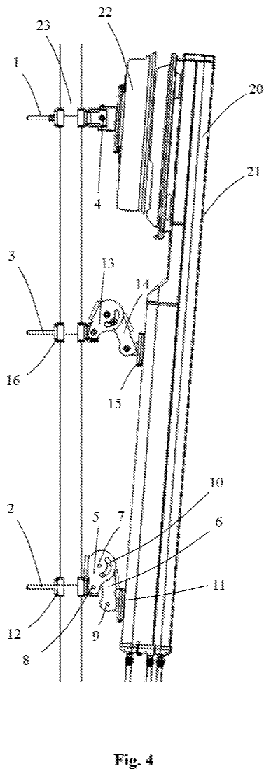

FIG. 5 and FIG. 6 are schematic diagrams of an antenna mounting device and antenna system in two different states according to the second embodiment of the present disclosure. The difference between the second embodiment and first embodiment may only be that the two articulating arms 5 and 6 of the second mounting unit 2 and the two articulating arms 13 and 14 of the third mounting unit open upwards. For other aspects, please refer to the description of the first embodiment.

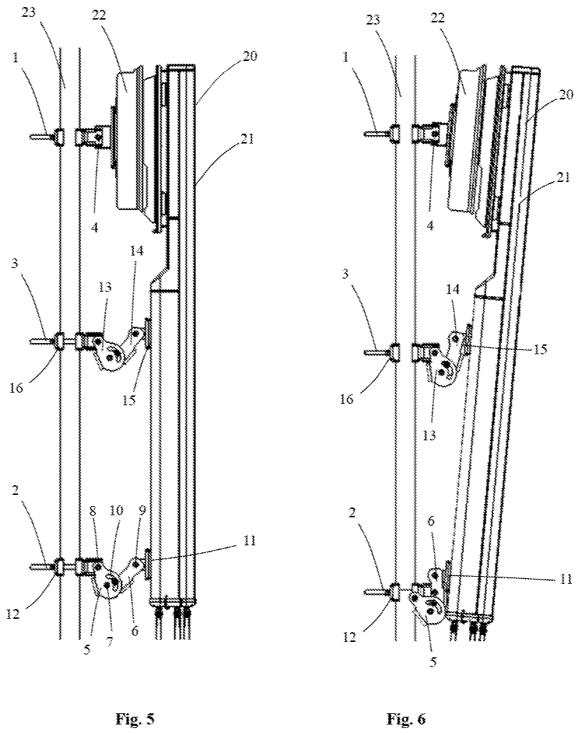

FIG. 7 is a schematic diagram of an antenna mounting device and antenna system according to the third embodiment of the present disclosure. In the third embodiment, the antenna mounting device only has a first mounting unit 1 and a second mounting unit 2, and does not have a third mounting unit, in which, the two articulating arms 5 and 6 of the second mounting unit 2 open upwards. For other aspects, please refer to the description of the first embodiment.

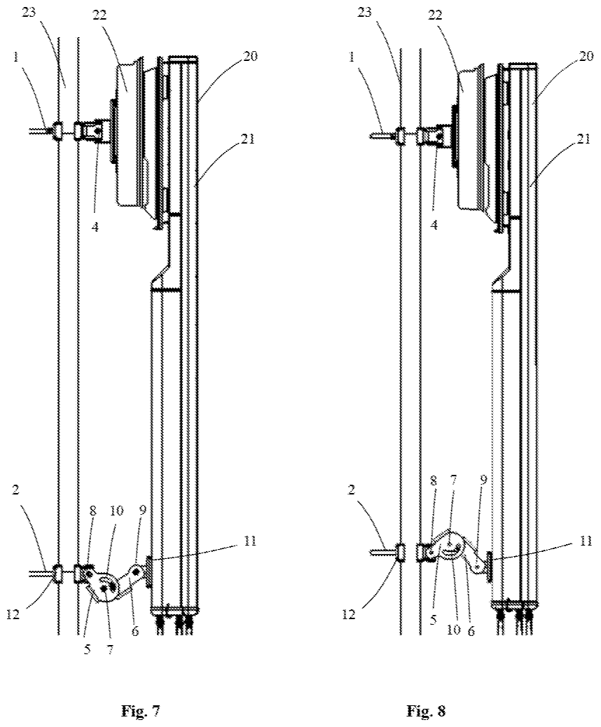

FIG. 8 is a schematic diagram of an antenna mounting device and antenna system according to the fourth embodiment of the present disclosure. In the fourth embodiment, the antenna mounting device only has a first mounting unit 1 and a second mounting unit 2, and does not have a third mounting unit, in which, the two articulating arms 5 and 6 of the second mounting unit 2 open downwards. For other aspects, please refer to the description of the first embodiment.

It will be understood that, the terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprise” and “include” (and variants thereof), when used in this specification, specify the presence of stated operations, elements, and/or components, but do not preclude the presence or addition of one or more other operations, elements, components, and/or groups thereof. As used herein, the term “and/or” includes any and all combinations of one or more of the associated listed items. Like reference numbers signify like elements throughout the description of the figures.

The thicknesses of elements in the drawings may be exaggerated for the sake of clarity. Further, it will be understood that when an element is referred to as being “on,” “coupled to” or “connected to” another element, the element may be formed directly on, coupled to or connected to the other element, or there may be one or more intervening elements therebetween. In contrast, terms such as “directly on,” “directly coupled to” and “directly connected to,” when used herein, indicate that no intervening elements are present. Other words used to describe the relationship between elements should be interpreted in a like fashion (i.e., “between” versus “directly between”, “attached” versus “directly attached,” “adjacent” versus “directly adjacent”, etc.).

Terms such as “top,” “bottom,” “upper,” “lower,” “above,” “below,” and the like are used herein to describe the relationship of one element, layer or region to another element, layer or region as illustrated in the figures. It will be understood that these terms are intended to encompass different orientations of the device in addition to the orientation depicted in the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive concept.

It will also be appreciated that all example embodiments disclosed herein can be combined in any way.

Finally, it is to be noted that, the above-described embodiments are merely for understanding the present invention but not constitute a limit on the protection scope of the present invention. For those skilled in the art, modifications may be made on the basis of the above-described embodiments, and these modifications do not depart from the protection scope of the present invention.

1. An antenna mounting device for antenna assembly, where the antenna assembly comprises a base station antenna that extends longitudinally and a remote radio unit mounted on a lateral surface of the base station antenna and adjacent to a longitudinal end of the base station antenna, wherein the antenna mounting device comprises:
a first mounting unit, where the first mounting unit is configured to pivotally connect a remote radio unit of the base station antenna assembly to a foundational component and provide the antenna assembly with a pivot point relative to the foundational component; and
a second mounting unit, where the second mounting unit is configured to connect the base station antenna of the base station antenna assembly to a foundational component in the longitudinal extension direction of the base station antenna, below the first mounting unit and at a distance from the first mounting unit, in which, the second mounting unit has an adjustable effective connection length between the base station antenna and foundational component, where the effective connection length determines the angle of the antenna assembly relative to the foundational component and thereby determines the mechanical tilt angle of the antenna assembly.

2. The antenna mounting device for an antenna assembly according to claim 1, wherein the antenna mounting device comprises a third mounting unit between the first mounting unit and second mounting unit in the longitudinal extension direction of the base station antenna, where the third mounting unit is configured to connect the base station antenna of the base station antenna assembly to the foundational component, in which, the third mounting unit has an adjustable effective connection length between the base station antenna and foundational component and the effective connection length of the third mounting unit adapts to the effective connection length of the second mounting unit.

3. The antenna mounting device for an antenna assembly according to claim 2, wherein the third mounting unit comprises a first articulating arm and a second articulating arm hinged to each other, where the first articulating arm of the third mounting unit is further configured to be connected by a hinge to the foundational component or an accessory fixedly connected to the foundational component and the second articulating arm of the third mounting unit is further configured to be connected by a hinge to the base station antenna or an accessory fixedly connected to the base station antenna.

4. The antenna mounting device for an antenna assembly according to claim 3, wherein the first articulating arm and second articulating arm of the second mounting unit open downwards or upwards.

5. The antenna mounting device for an antenna assembly according to claim 1, wherein the second mounting unit comprises a first articulating arm and a second articulating arm hinged to each other, where the first articulating arm of the second mounting unit is further configured to be connected by a hinge to the foundational component or an accessory fixedly connected to the foundational component, and the second articulating arm of the second mounting unit is further configured to be connected by a hinge to the base station antenna or fixedly connected to an accessory of the base station antenna

6. The antenna mounting device for an antenna assembly according to claim 5, wherein the first articulating arm and second articulating arm of the second mounting unit open downwards or upwards.

7. The antenna mounting device for an antenna assembly according to claim 1, wherein the second mounting unit comprises a lockable locking device and the locking device is configured to lock the effective connection length of the second mounting unit.

8. The antenna mounting device for an antenna assembly according to claim 1, wherein the effective connection length of the second mounting unit is stepless-adjustable or step-adjustable.

9. The antenna mounting device for an antenna assembly according to claim 1, wherein measuring in the longitudinal extension direction of the base station antenna,
the longitudinal distance between the connection between the first mounting unit and the remote radio unit and the longitudinal end of the base station antenna is no larger than ⅙ of the size of the longitudinal extension of the base station antenna; and/or
the longitudinal distance between the connection between the second mounting unit and the base station antenna and the other longitudinal end of the base station antenna that is opposite the longitudinal end may not be larger than ⅙ of the size of the longitudinal extension of the base station antenna.

10. An antenna system, comprising an antenna assembly, where the antenna assembly comprises a base station antenna that extends longitudinally and a remote radio unit mounted on a lateral surface of the base station antenna and adjacent to a longitudinal end of the base station antenna, wherein the antenna system comprises an antenna mounting device for antenna assembly according to claim 1, where the antenna assembly is mounted onto the foundational component via the antenna mounting device.

11. The antenna system according to claim 10, characterized in that the first mounting unit is directly pivotally connected to the remote radio unit.

12. An antenna system, comprising:
an antenna assembly comprises a base station antenna that extends longitudinally and a remote radio unit mounted on a surface of the base station antenna and adjacent to one end of the base station antenna; and
an antenna mounting device comprising:
a first mounting unit pivotally connected to the remote radio unit of the base station antenna assembly and configured to be mounted to a foundational component; and
a second mounting unit pivotally connected to the base station antenna of the base station antenna assembly and configured to be mounted to the foundational component below the first mounting unit and at a distance from the first mounting unit, the second mounting unit comprising a plurality of articulating arms, the second mounting unit configured to move a lower end of the base station antenna assembly relative to the foundational component to adjust a distance between the lower end of the base station antenna assembly and the foundational component and thereby adjust a mechanical tilt angle of the antenna assembly.

13. The antenna system according to claim 12, wherein the antenna mounting device further comprises a third mounting unit pivotally connected to the base station antenna of the base station antenna assembly and configured to be mounted to the foundational component below the first mounting unit, the third mounting unit comprising a plurality of articulating arms.
